(19) United States
(12) Patent Application Publication
(10) Pub. No.: US 2018/0355248 A1
(43) Pub. Date: Dec. 13, 2018

(54) A GROUND COVER MULCH COMPRISING A MICROFIBRILLATED POLYSACCHARIDE

(71) Applicant: STORA ENSO OYJ, Helsinki (FI)

(72) Inventors: Kaj Backfolk, Lappeenranta (FI); Isto Heiskanen, Imatra (FI); Carl-Mikael Tag, Tuusula (FI); Ville Ribu, Lappeenranta (FI)

(21) Appl. No.: 15/779,158

(22) PCT Filed: Nov. 25, 2016
(86) PCT No.: PCT/IB2016/057129

§ 371 Date: May 25, 2018

(30) Foreign Application Priority Data
Nov. 27, 2015 (SE) 1551542-2

(51) Int. Cl. C09K 17/52; C05G 3/02; C05G 3/04; D21H 15/10; D21H 21/36; D21H 21/28; D21H 17/67; D21H 19/52; A01G 13/02

(52) U.S. Cl. CPC C09K 17/52; C05G 3/02; C05G 3/04; D21H 15/10; A01G 13/0275; D21H 21/28; D21H 17/67; D21H 19/52; D21H 21/36

(57) ABSTRACT

The present invention relates to a ground cover in the form of a mulch, comprising a microfibrillated polysaccharide. Also methods for its manufacture and use thereof are disclosed.

### FIELD OF INVENTION

The present invention relates to agriculture and in particular a ground cover in the form of a mulch, comprising a microfibrillated polysaccharide. Also methods for its manufacture and use thereof are disclosed. The cover is further compostable and biodegradable.

### BACKGROUND

A common solution today is to use plastic based films before planting the seeds. This plastic film prevent weed from growing, reduces amount of needed pesticides, fungicides or herbicides, enhances temperature of the soil, and control moisture content of soil. The use of mulches in agriculture is as said dominated by various plastic films and composites. The use of such a film also protect the crop from weed infestation, weed growth, and insects etc. One possible mode to control pests, diseases, insects, pathogens, parasites and weed, is to fumigate the soil. However, the fumigation is usually being more effective if covering with a plastic film that prevents the release of fumigant or volatile organic components (VOCs) within the fumigant. It also enables the use of less fumigant and reduces the fumigant emission and minimize worker exposure to the fumigants. Most of the plastic developed for this purpose are not sustainable or made from sustainable materials although being biodegradable. The use of a paper based material, on the other hand, is environmental concept but too usually too porous to improve the fumigation process.

One of the problems with plastic is that the farmers do not collect the plastic film back after harvesting the crop. This is one reason why biodegradable and sustainable solutions need to be implemented. Changes in EU legislation seem also to favor biodegradable alternatives in the near future.

In JP2001-279106 discloses a sheet comprising cellulose microfibers that can be used in agricultural applications is disclosed. Nothing is however mentioned about mulch.

In WO2012101329 it is also disclosed a ground-cover mulch, which includes a web-formed vegetable fibre-bearing pulp, and wood distillate. The wood distillate includes birch-wood distillate. In addition, the disclosure also relates to a method for manufacturing ground-cover mulch and the use of birch-wood distillate in ground-cover-mulch applications.

The paper based alternatives face problem with biodegradability and microbial attacks and costs. There is thus a need to solve the above problems and still maintain the important physical criteria needed for paper-based mulched such as high strength, elasticity, controlled microbial degradability and cost efficient product. Also there is a need for a ground cover, preferably in the form of a mulch that provides a fumigant preserving effect.

To summarize the background art shows that paper mulches have been used. However, industrial use of paper or cellulose films is usually limited by costs, mechanical performance, and by too fast biodegradability. Various components may be added to a paper surface to adjust and to control its properties, but it usually adds a lot of costs. There is therefore a need to solve one or more of the above problems e.g. the lack of fumigant preserving effect and the related problems such as to minimize the exposure to workers.

The present invention addresses the problems of degradable paper based mulches which also includes lack of fumigant preserving effect (too much evaporation of fumigants). Due to wet conditions and high microbe contents in the soil, bio-based mulches such as paper based mulches, needs to be treated in order to provide controlled rate of degradation. At the same time, the paper mulch or biofilm should be eco-friendly and have certain physical properties and be durable against water and wind. There is thus a need for an improved ground cover, preferably in the form of a mulch which in addition addresses the problem with fumigant preserving effect. It has now surprisingly been found, that by using a microfibrillated polysaccharide, a cover can be provided with such properties that solves one or more of the problems connected with cellulose based ground covers, such as mulches.

### SUMMARY OF INVENTION

The present invention thus solves one or more of the above problems, by providing according to a first aspect a ground cover mulch, providing a fumigant preserving effect, which comprises a thermoplastic or a paper substrate originating from fibre-bearing pulp, preferably emanating from lignocellulosic material, which has been web-formed or sheet formed or film formed, characterized in that said cover in addition comprises at least one layer of microfibrillated polysaccharide. Thus said at least one layer microfibrillated polysaccharide forms a part of the mulch which in addition comprises at least one thermoplastic substrate or one paper substrate.

Also provided according to a second aspect of the invention is a method for manufacturing a ground cover mulch according to the first aspect of the present invention, with the proviso that it is based upon a paper substrate, comprising the following steps:
a) providing a fiber suspension originating from fibre-bearing pulp, preferably emanating from lignocellulosic material,
b) optionally adding one or more functional agent(s), and optionally also one or more filler(s), to the fibre suspension,
c) forming a paper/board web substrate or sheet, and
d) adding a microfibrillated polysaccharide, such as microfibrillated cellulose (MFC), preferably ending up in the form of a film or coating, optionally followed by drying thus providing a film, thus providing a mulch. Said “adding” may either be performed by coating, surface sizing, or lamination. Example of coating processes are blade coating, surface sizing with film press, foam coating, curtain coating, spray coating, etc. Coating may be done on both a wet or a dry web. Said microfibrillated polysaccharide may further be added either as a top and/or back layer in a wet forming process, or via a surface treatment step or via a lamination step.

Also provided according to a third aspect of the invention is a method for manufacturing a mulch according to the first aspect, with the proviso that it is based upon a thermoplastic, comprising the following steps:
e) providing a film comprising a thermoplastic or a combination of thermoplastics, and
f) applying a microfibrillated polysaccharide, such as microfibrillated cellulose (MFC), preferably ending up in the form of a film, optionally followed by drying thus providing a film, thus providing a mulch. This application may be done through forming a laminate which may involve gluing.

Also provided according to a fourth aspect of the invention is a ground cover mulch, obtainable by a method according to the second aspect.

Also provided according to a fifth aspect of the invention is use of ground cover mulch, according to the first aspect in cultivation. This embraces also the use in farming and horticulture.

### DETAILED DESCRIPTION OF THE INVENTION

The expressions “fibre” and “fiber” are used interchangeably in the present description meaning the same thing.

The pulp mentioned in the present description, may be chemical pulp, mechanical pulp, thermomechanical pulp or chemi(thermo)mechanical pulp (CMP or CTMP). Said chemical pulp is preferably a sulphite pulp or a kraft pulp.

The pulp may consist of pulp from hardwood, softwood or both types. The pulp may e.g. contain a mixture of pine and spruce or a mixture of birch and spruce. The chemical pulps that may be used in the present invention include all types of chemical wood-based pulps, such as bleached, half-bleached and unbleached sulphite, Kraft and soda pulps, and mixtures of these. The pulp may be of dissolving pulp. The pulp may also comprise textile fibers. The pulp may also come from agriculture (e.g. potato, bamboo or carrot). The pulp may also be so called nanopulp (Microfibrillated cellulose, nanocellulose, fibrillated regenerated cellulose, or modified versions thereof such as TEMPO or carboxymethylated pulp). The pulp may also be recycled pulp, broke, sludge. Also combinations of said pulp types are possible in the context of the present invention. The pulp may also contain synthetic fibers or biofibers such as PLA (Poly-lactic acid).

It is intended throughout the present description that the expression “microfibrillated polysaccharide” embraces any type of microfibrillated cellulose, such as microfibrillated cellulose fibres (cellulose material). The cellulose may also be a microfibrillated cellulose (MFC, which is preferred) or nanocellulose, nanofibrillated cellulose (NFC) or cellulose nanofibrils (CNF). The microfibrillated cellulose may be bleached or unbleached. The cellulose may also be nanocrystalline cellulose (NCC) or microcrystalline cellulose (MCC).

The microfibrillated cellulose or nanocellulose can also be modified versions, which also includes chemically modified versions, such as TEMPO oxidated or carboxymethylated nanocellulose. Other modifications such as chemical or physical modifications in order to achieve hydrophobic properties or/and improved gas barrier (fumigant) properties is also included.

The cellulose may emanate from a pulp, which may be chemical pulp, mechanical pulp, thermomechanical pulp or chemi (thermo) mechanical pulp (CMP or CTMP). Said chemical pulp is preferably a sulphite pulp or a Kraft pulp. In microfibrillated cellulose the individual microfibrils have been partly or fully detached from each other. In this definition, we also include a high quality MFC in which substantial part of elementary nanofibrils have been liberated from the fibers or microfibrillated aggregates. MFC can be made with different means such as mechanical treatment of pulp with or without a hydrolysis step or chemical modification. Typical hydrolysis is done by using enzymatical, or other swelling agents. Thus, an energy efficient solution is by combining e.g. chemical and mechanical treatment steps.

The pulp initially used in the method according to the first aspect, may consist of pulp from hardwood, softwood or both types. The pulp may e.g. contain a mixture of pine and spruce or a mixture of birch and spruce. The chemical pulps that may be used in the present invention include all types of chemical wood-based pulps, such as bleached, half-bleached and unbleached sulphite, Kraft and soda pulps, and mixtures of these. The pulp may be of dissolving pulp type. The pulp may also comprise textile fibers. The pulp may also come from agriculture (e.g. potato, bamboo or carrot).

A microfibrillated cellulose fibril is further normally very thin (such as ˜20 nm) in diameter and the length is often between 100 nm to 10 μm. The elementary fibril is about 3-5 nm. However, the microfibrils may also be longer, for example between 10-200 μm, but lengths even 2000 μm can be found due to wide length distribution. Fibers that have been fibrillated and which have microfibrils on the surface and microfibrils that are separated and located in a water phase of a slurry are also included in the definition MFC. Furthermore, whiskers are also included in the definition MFC.

The microfibrillated cellulose is typically made from wood cellulose fibers, it is as said possible to use both hardwood and softwood fibers. It can also be made from microbial sources, agricultural fibers, such as wheat straw pulp, bamboo or other non-wood fiber sources. It can also be produced by bacteria or made simultaneously, in the form of a by-product (primarily comprising whiskers or crystalline parts which may have a low DS i.e. a low degree of substitution), when CMC is manufactured.

It is intended throughout the present description that the expression “thermoplastic” embraces any thermoplastic polymer (which may be of fossil origin) that may be useful in the context of the manufacturing of ground covers, such as mulches. Said polymer may be, but is not limited to acrylates such as PMMA, PP (Polypropylene), PE (Polyethylene) such as HDPE (high density PE), MDPE (medium density PE), LDPE (low density PE), PA (Polyamide) such as nylon, PS (Polystyrene), Polyvinylchloride (PVC), polysulfone, ether ketone or polytetrafluoroethylene (PTFE). The PE may further be cross-linked (PEX). It may further be co-polymers comprising two or more of said polymers or mixtures comprising two or more of said polymers. Preferably PP (Polypropylene) or PE (Polyethylene) is used.

According to a further preferred embodiment of the first aspect of the invention the microfibrillated polysaccharide is present as a film on top of one or both sides of the mulch, preferably on top of the side facing the soil when in use. The film may also comprise other bioactive chemicals obtained from the tree such as various lignin derivatives, hemicellulose, etc. The microfibrillated polysaccharide film may comprise various types of “MFC qualities”. For example it may comprise coarse MFC, and TEMPO oxidated MFC, or MFC and CNC or combinations thereof. The film may also comprise other additives such as water repelling agent (waxes, AKD, ASA, resins, etc.) or chemicals that improves gas barrier properties (PVA, CMC, starch, nanopigments, etc.)

According to a further preferred embodiment of the first aspect of the invention the microfibrillated polysaccharide is present in a sandwich configuration, preferably when a paper substrate is used.

According to a further preferred embodiment of the first aspect of the invention said mulch contains additionally one or more fillers. Said filler may be a black filler, preferably carbon black, most preferred combined with a filler selected from the group comprising calcium carbonate, talc, kaolin, precipitated carbonate, silica, fly ash and aluminium oxides or combinations thereof. The fillers may be added both to wet end or via surface treatment step, or both.

According to a further preferred embodiment of the first aspect of the invention said mulch comprises one or more functional agents such as one or more colorant(s) and/or one or more performance chemical(s). The performance chemical(s) may preferably be selected from the group: strength additives, hydrophobic agents and retention chemicals or combinations thereof. The colorant(s) may preferably include one or more UV absorbents. This expression also comprises a chemical that absorbs irradiation during day and release it slowly during night. The UV absorbent may also be a stimulant for photosynthesis.

According to a further preferred embodiment of the first aspect of the invention said mulch comprises one or more biocide(s), pesticides, fungicides and/or nutrient(s). The biocides may be a fungicide or a bactericide or a combination thereof.

According to a further preferred embodiment of the first aspect of the invention said mulch comprises the carbon black emanates from a non-fossil source, preferably from biomass or organic waste residues of non-fossil origin. The carbon black may preferably emanate from lignin.

According to a further preferred embodiment of the method according to the second aspect of the present invention the forming is made with a dry or wet laid process, preferably a wet laid process. This may also comprise a multiply forming technique.

According to a further preferred embodiment of the method according to the second aspect of the present invention steps b), c), and, optionally d), are performed at the wet end of a paper/board production line.

According to a further preferred embodiment of the method according to the second aspect of the present invention step b) also comprises adding one or more biocide(s) and/or nutrient(s).

It has as said been found, that by applying a thin microfibrillated polysaccharide (preferably MFC) film on a mulch, preferably paper but not limited to this, it is possible to improve the soil fumigation. The microfibrillated polysaccharide (preferably MFC) film, which is in contact with the soil, is also capable of retaining the fumigant and does also provide a moisture retention property to the soil. The mulch according to the first aspect of the present invention further provides a laminate structure that has good gas barrier properties, which then allows less fumigants to evaporate into the environment. An additional benefit is also that it minimize exposure to workers but it also concentrates the fumigants to the soil surface. The layer comprising the microfibrillated polysaccharide, preferably in the form of a film, may in addition provide a temporary barrier. The layer may also comprise other structures such as PLA-MFC or PE-MFC which are likely to provide a similar effect.

The mulch according to the first aspect of the present invention may further be measurably beneficial for greenhouse environments to improve heat retention in winter and cooling in summer.

Preferred features of each aspect of the invention are as for each of the other aspects mutatis mutandis. The prior art documents mentioned herein are incorporated to the fullest extent permitted by law.

In view of the above detailed description of the present invention, other modifications and variations will become apparent to those skilled in the art. However, it should be apparent that such other modifications and variations may be effected without departing from the spirit and scope of the invention.

1. A ground cover mulch, providing a fumigant preserving effect, which comprises a thermoplastic or a paper substrate originating from a fibre-bearing pulp, which has been web-formed or sheet formed or film formed, wherein the cover further comprises at least one layer of microfibrillated polysaccharides.

2. The mulch according to claim 1 wherein the microfibrillated polysaccharide is present as a film or coating on at least one side of the mulch.

3. The mulch according to claim 1 wherein the microfibrillated polysaccharide is present in a sandwich configuration.

4. The mulch according to claim 1 wherein the microfibrillated polysaccharide is microfibrillated cellulose (MFC).

5. The mulch according to claim 1 containing additionally one or more fillers.

6. The mulch according to claim 5, wherein the filler is a black filler.

7. The mulch according to claim 1 also comprising one or more functional agents, namely at least one colorant and/or at least one performance chemical.

8. The mulch according to claim 7 wherein the at least one performance chemical is selected from the group: strength additives, hydrophobic agents and retention chemicals or combinations thereof.

9. The mulch according to claim 7 wherein the colorant includes one or more UV absorbents.

10. The mulch according to claim 1 further comprising one or more biocides and/or nutrients.

11. The mulch according to claim 6 wherein the black filler comprises carbon black that emanates from a non-fossil source.

12. A method for manufacturing a mulch according to claim 1, that is based upon a paper substrate, comprising the following steps:
a) providing a fiber suspension originating from fibre-bearing pulp,
b) forming a paper/board web substrate or sheet, and
c) adding a microfibrillated polysaccharide.

13. The method for manufacturing a mulch according to claim 12 wherein the forming is made with a dry or wet laid process.

14. The method for manufacturing a mulch according to claim 12 wherein step b) is performed at the wet end of a paper/board production line.

15. The method for manufacturing a mulch according to claim 12 further comprising after step a) adding one or more functional agents and adding one or more biocide(s) and/or nutrient(s) to the fibre suspension.

16. A method for manufacturing a mulch, that is based upon a thermoplastic, comprising the following steps:
a) providing a film comprising a thermoplastic or a combination of thermoplastics, and
b) applying a microfibrillated polysaccharide, thus providing a mulch.

17. A ground cover mulch, obtainable by a method as set claim 12.

18. (canceled)

19. A ground cover mulch, obtainable by a method as set out in claim 16.

20. The mulch according to claim 1 wherein the fibre-bearing pulp, emanates from lignocellulosic material.

21. The mulch according to claim 1 wherein the microfibrillated polysaccharide is present as a film or coating on top of a side facing the soil when in use.

22. The mulch according to claim 5, wherein the filler is carbon black.

23. The mulch according to claim 5, wherein the black filler is combined with a filler selected from the group consisting of: calcium carbonate, talc, kaolin, precipitated carbonate, silica, fly ash, aluminum oxides and combinations thereof.

24. The mulch according to claim 6 wherein the black filler emanates from biomass or organic waste residues of non-fossil origin.

25. The method of claim 12 wherein the fiber suspension emanates from lignocellulosic material.

26. The method of claim 12 further comprising adding at least one functional agent to the fibre suspension.

27. The method of claim 12 further comprising adding at least one filler to the fibre suspension.

28. The method of claim 12 wherein the microfibrillated polysaccharide is microfibrillated cellulose (MFC).

29. The method of claim 12 further comprising a drying step after step c).

30. The method of claim 16 wherein the microfibrillated polysaccharide is microfibrillated cellulose (MFC).
